(19) United States
(12) Patent Application Publication
(10) Pub. No.: US 2005/0279172 A1
(43) Pub. Date: Dec. 22, 2005

(54) Visualization, measurement and analysis of vibrating objects

(76) Inventors: Hubert W. Schreier, Columbia, SC (US); Peter Mackel, Kassel (DE)

Correspondence Address: Michael A. Mann;Nexsen Pruet, LLC, Post Office Drawer 2426, Columbia, SC, 29202-2426, US

(21) Appl. No.: 11/154,322

(22) Filed: Jun. 16, 2005

(30) Foreign Application Priority Data
Jun. 18, 2004 (DE) 10 2004 029552.2

(51) Int. Cl. G01D 5/32; G01N 21/41

(52) U.S. Cl. 73/657; 73/655; 73/618

(57) ABSTRACT

A simple, relatively inexpensive, non-contacting, full-field (total visible surface) measurement and visualization methodology is described to measure the object motions and the object stretches and object distortions (deformations) during oscillation of an object. The method is capable of full-field measurement of 1D, 2D and/or 3D object motions and the associated object surface deformations on vibrating objects. The methodology is based on a combination of stroboscopic image ascuisition and/or controlled image exposure time with a synchronization system to acquire the images at appropriate times during periodic oscillation of an object; the periodicity of the applied excitation is used to mitigate the requirement for high speed imaging. Then, image matching procedures, such as 3D digital image correlation, are used with software to extract full-field object motions and surface deformations at each time of interest.

### CROSS REFERENCE TO THE RELATED PARTIES

Priority Claim

The present application claims the priority benefit of German patent application number 10 2004 029 552.2, filed on Jun. 18, 2004.

### BACKGROUND OF THE INVENTION

It is well-known that oscillations are measured by means of sensors such as accelerometers, linear velocity displacement transducers and displacement gauges. These methods measure motions locally at a few discrete locations through contact with the surface. Due to their mass, such sensors can affect the response of the object being measured, which is not the case for optical, non-contacting measurements.

In addition to the effects of mass on the response of an object, such methods typically measure object motions and deformations only along a specific direction and at discrete points. To obtain measurements of motion in all directions at a point, either a combination of several sensors located at the same point or a combination of several experiments with sensors oriented in distinct directions at the same point is required to obtain all of the motion components at a given point. Even if multiple sensors are used, a measurement of the deformations of the object surface caused by the oscillations cannot be determined using motion data at a single position since the gradients of the deformation are required. Due to the size and weight of these sensors, it is not possible to place additional sensors sufficiently near the same point to acquire accurate measurements of the surface deformations.

There remains a need for better ways of measuring and analysing objects.

### SUMMARY OF THE INVENTION

The present invention uses optical measurement methods that do not contact the surface and as such do not affect the response of the object. Laser vibrometers are capable of acquiring motion measurements for vibrating objects without contacting the surface. In its standard form, a laser vibrometer acquires measurements at one point.

A scanning laser vibrometer can operate in a manner that scans across the object, acquiring motion measurements at several positions on the object surface. A disadvantage of the method is that the scan time increases according to the density of the measuring points. A further disadvantage of any scanning laser vibrometer is the missing reference to an object point for the measurement of relative object motions between points on the object surface. The primary quantity measured by laser vibrometers is the relative phase change and/or the rate of change due to the optical path length variation induced by object surface motions. The sensitivity direction is given by the combination of illumination and observation angle. That is, measurements are made along a line of sight without direct reference to a fixed object point. Therefore, a measurement of the relative motion of two object points is impossible and strain measurements cannot be obtained in the general case. A further disadvantage are the high costs due to the use of expensive optical components, coherent light sources, vibration isolation components and the requirements to have a highly reflective object surface during the measurement process.

Speckle interferometry methods, such as speckle holography or speckle shearography, are non-contacting methods that can be used to obtain full-field (total visible surface) motion measurements during object vibrations and/or oscillations. These methods can provide a direct reference to the object surface and thus, the determination of object strains is possible. A major disadvantage of these procedures is that the coherent illumination and measurement process can only be used to measure small object motions due to the high sensitivity of interferometric methods. Additional disadvantages include the deleterious effects of (a) small environment disturbances and (b) rigid body motion of the object relative to the recording medium. A further disadvantage is the high cost due to the use of expensive optical components and coherent light sources.

Digital speckle photography or digital image correlation is a non-contacting measurement method that was originally developed to measure the 2D deformations of an object subjected to a change in loading (i.e. static loading change). The method stores images of a randomly varying intensity pattern in the two loading states and uses software to compare sub-regions in each pattern to extract Full-field measurements of surface displacement. The random pattern provides a locally unique set of markers to allow for determination of correspondences between many small sub-sets within the image so that it is possible to measure a full-field of local surface deformations. Known as a speckle pattern, the randomly varying intensity field may be naturally occurring or artificially applied.

High speed 2D digital image correlation uses a high speed camera and the concepts of 2D digital image correlation to acquire images of a planar object surface at various times and software to extract 2D Full-field object motions at each time.

The method can be extended to high-speed stereo speckle photography or 3D digital image correlation where multiple high speed cameras simultaneously record digital images of the object surface at each time, t, and software is used to extract 3D Full-field object motions at each time. A major disadvantage of all high-speed camera systems is the high cost of the cameras required to obtain the data. An additional disadvantage is the relatively small number of images that can be stored in typical high speed cameras.

### BRIEF DESCRIPTION OF THE DRAWINGS

FIG. 1 depicts continuous illumination with controlled application of reduced exposure times according to a preferred embodiment of the present image acquisition system;

FIG. 2 depicts controlled stroboscopic illumination for adequate exposure in an alternate preferred embodiment of the present image acquisition system;

FIG. 3 illustrates a procedure to control exposure time or stroboscopic illumination to extract phase response from separate excitation cycles according to a preferred embodiment of the present invention; and

FIG. 4 is a typical example of a speckle pattern, subsets of that pattern and changes in shape of the subsets due to object deformation and/or viewing angle.

### DESCRIPTION OF THE INVENTION

The presented invention is a procedure to easily and cost-effectively measure and visualize the shape of an object, the motions of an object and the deformations of an object undergoing vibratory oscillation. The method is essentially a combination of stroboscopic image acquisition methods with digital image correlation, particularly 3D digital image correlation, or other image analysis methods, e.g., marker tracking. By means of stroboscopic image recording mechanisms and/or reduced exposure time during image acquisition, sharp images of a vibrating object can be acquired and analysed by digital image correlation or other image processing methods to obtain the object motions. Other derived quantities such vibration amplitudes and phase maps as well as surface strains can then be obtained from the object motions. Procedures and implementations will be referred to as Vibro-Correlation Systems (VIC-S) in the following. In particular, they can be used for vibration measurements according to the phase resonance method.

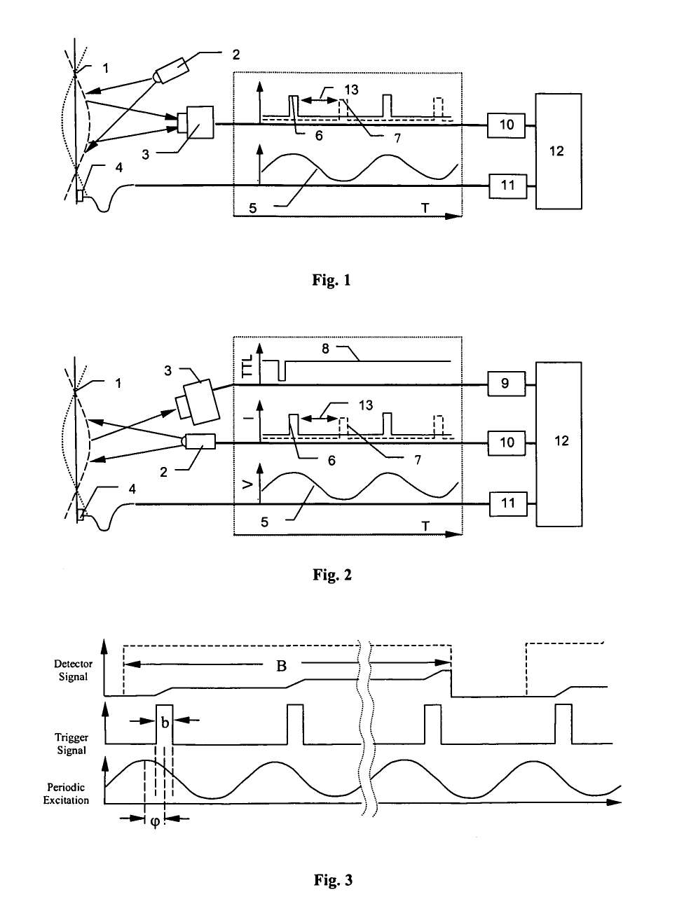

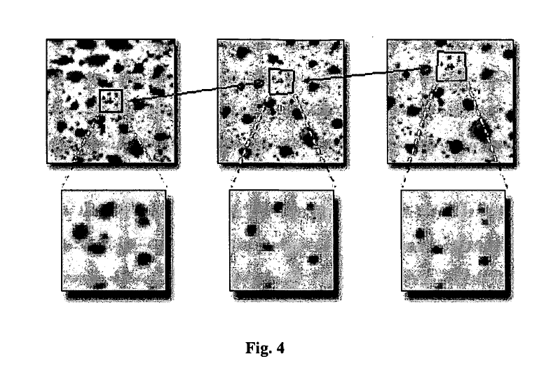

FIGS. 1 and 2 show schematics of typical VIC-S arrangements. In this invention, the VIC-S measures Full-field surface positions of an oscillating/vibrating object (1 in FIGS. 1, 2). Images of the vibrating object surface are obtained with image and recording devices (3 in FIGS. 1, 2) by use of a synchronization unit (12 in FIGS. 1,2) to trigger the instant when an image is recorded (output from 10,9 in FIGS. 1,2) with the periodic oscillations (5 in FIGS. 1, 2) being applied to the object. The recorded image is frozen in time using either stroboscopic lighting (2 in FIG. 2 with 6, 7 in FIG. 2 to control illumination time), continuous illumination (2 in FIG. 1) with reduced exposure times (6, 7 in FIG. 1 to control exposure time) for imaging or a combination of both approaches. The images are analyzed using image comparison procedures (see FIG. 4 for an example using a speckle pattern) to extract full-field object response including surface shape as a function of time, deformations as a function of time, and phase response as a function of time.

Considering a specific applied frequency of oscillation, several well-focused, sharp images are acquired that correspond to various times during any cycle of periodic oscillation of the object simply by slightly shifting the phase of the periodic lighting and/or the exposure time sequence (see locations identified by b with shift of φ in FIG. 3). After recording multiple images of the vibrating object, 3D digital image correlation procedures (FIG. 4) are used to obtain the full-field object motions and the surface strains. Furthermore, by selecting any two images from the image sequence, quantities of interest such as (a) peak-to-peak relative motions of the object (locations 6 or 7 with 13 in trigger signal 10 of FIG. 1), (b) the phase at various positions on the object (as per FIG. 3) and (c) the frequency response and the surface deformations (e.g., surface strains) on the object surface for the specific applied frequency of oscillation. A distinct advantage of the approach shown schematically in FIG. 3 is that this process mitigates the need for high-speed image acquisition while reconstructing the full-field motions and phase response of the object.

The entire process described above is repeated for any/each/all applied frequencies of oscillation to obtain the entire frequency response of the object.

### DETAILED DESCRIPTION OF THE INVENTION

FIGS. 1 and 2 presents the invention procedure. Any periodic object oscillation (1) process is applied to induce vibratory motion of the object surface (4). Then, the object surface motion is optically frozen at any place and/or oscillation phase position, so that well-focused, sharp images of the object are acquired.

### Optical Freezing

The optical freezing process can be realized in various ways. One approach is to continuously illuminate the object surface (2 in FIG. 1) and use a synchronization unit (12) to perform synchronisation of the image acquisition process at each time of interest during the oscillation process with short exposure time (3 in FIG. 1 with trigger signal 10). Another approach is shown in FIG. 3 and employs stroboscopic control of object illumination (2 in FIG. 2 with trigger signal 10 from 12). A final approach uses a combination of both reduced exposure time and stroboscopic illumination using well-known procedures.

It is noted that, since the optical freezing process can be used for general excitation, it also can be used to freeze the motion when the object is subjected to oscillation frequencies that result in resonance conditions.

### Imaging Components

The image acquisition and recording process can take place electronically by means of devices such as CCD cameras or CMOS cameras or other systems that convert the image into digital form (3 in FIGS. 1, 2).

### Imaging System

Several types of imaging systems can be used, including stereo camera systems, whereby the image planes of multiple cameras in the stereo system are directed toward the object from different directions. Due to the different views obtained by the cameras, triangulation procedures can be used to determine the three-dimensional positions of the total surface at any time. Data processing can be performed to determine the slopes and curvatures of the surface at any position on the object surface.

In another embodiment of the system, multiple cameras are used in the stereo camera system, with some or all of the image planes being parallel to each other and the cameras shifted relative to each other (parallel sensor planes).

### Image Acquisition Synchronization

The time for recording of a frozen image is selected by a synchronization unit (12) via an electrical signal (10) that is used to trigger the image acquisition process. The trigger signal indicates the time at which an image is recorded so that images can be acquired with arbitrary phase position, Φ, relative to the excitation signal. Since the trigger signal can be sent at any time, the trigger signals can be shifted in time to record data at the same phase location after N additional cycles of oscillation have elapsed. The process described above is shown in FIG. 3. In this case, the phase of the recorded images is shifted by 2πN+Φ, where N is the number of cycles of oscillation that have elapsed since the previous recorded image. In this manner, images do not have to be acquired all within a single cycle of oscillation, and relatively small image acquisition rates are sufficient in order to reconstruct the complete phase history of the periodic oscillation.

In the preferred embodiment of the system, the frequency of the outgoing trigger signal from the synchronisation system is selected in such a way that it can be represented as the quotient of the frequency of the vibrating object and a divisor (including the divisor 1). By selecting divisors greater than unity, triggering for image acquisition across many cycles is possible and need not occur within a single oscillation. Thus, relatively slow image acquisition rates and/or low flash frequencies will be sufficient to freeze images and obtain images that can be used to reconstruct the phase response at any relative phase shift to represent the profile, stretches and distortions during oscillation of the object (FIG. 3).

### Trigger Signal Sources

A motion sensing device (4 in FIGS. 1,2) that senses the input periodic excitation in real-time is used to send a signal (11 in FIGS. 1,2) to the synchronization unit to automatically adjust synchronization. Once received, the synchronization unit provides trigger signals to the camera (10 in FIG. 1) and/or the stroboscopic unit (11 in FIG. 2) that reflects changes in the object's oscillating frequency and phase.

An additional embodiment of the system employs an existing synchronization signal from the periodic oscillator/exciter so that trigger signals from the synchronization system reflect the input oscillating frequency and phase (equivalent to transmission of 11 by unit 12 in FIGS. 1, 2).

In another embodiment of the system, the frequency of the input oscillation is not measured. Instead, a periodic signal of arbitrary form and frequency is produced by the synchronisation system and input directly into one or more excitation units to actively control the input excitation to the object. In addition, the synchronization unit is also used at the same time for triggering, so that the frequency and phase data for acquiring images is in direct correspondence with the excitation.

In another embodiment of the system, the synchronisation can be performed using a default or manually set excitation frequency, without requiring any input signals or analyses of measured oscillations.

In another embodiment of the system, incremental phase shifts can be applied sequentially to the periodic trigger signal so that images are acquired at discrete, specified phase shifts.

Regardless of the approach used to sense the excitation frequency, in all embodiments of the method the signal received by the synchronization component is analyzed to determine the primary periodic frequency component. This information is used to define the relative phase position of the output trigger pulses.

### Use of Trigger Signal

As noted previously, the trigger signal can be used to initiate the optical freezing process by (a) signalling the electronic imaging system to expose an image (6,7,13 in trigger signal 10 in FIG. 1), (b) signalling the stroboscopic lighting system to flash for a designated period of time (6,7,13 in trigger signal 10 in FIG. 2) or (c) signalling both the electronic imaging system(s) and the stroboscopic lighting system(s) so that the combination works together to freeze the image.

### Electronic Exposure Time

In electronic imaging systems, the exposure time can be varied at the image plane by a range of shuttering methods, including electronic, mechanical and optical shutters. The shuttering method determines the length of the integration and/or exposure time of the camera required to obtain good quality images with sufficient contrast and without motion blur.

### Stroboscopic illumination

There are many stroboscopic illumination systems with adjustable illumination times (width of rectangular pulses in 10) that can be triggered to freeze an image. In each case, the illumination interval is adjusted to obtain good quality images.

### Multiple Exposures at Same Relative Phase

For situations where a single light strobe does not provide sufficient intensity and the electronic shutter time is too high to freeze the object motion, the synchronization unit is used to trigger multiple light strobes at identical phase angles over multiple vibration cycles while the camera exposes. In this case, each image recorded is the integration of the individual flashes by means of appropriate exposure time of the camera. This is shown in FIG. 3.

### Image Filtering

An additional aspect of the invention is that background radiation/lighting can be suppressed during the image acquisition process using optical filters co-ordinated with the lighting frequency, in particular band-pass filters (interference filter).

### Patterning of Object Surface

In all embodiments of the system, the object surface (1) has a characteristic image pattern that can be used to identify the object points in the recorded images through well-known image matching processes. In the preferred embodiment of the method, the pattern has a random variation across the visible object surface that is known as a speckle pattern. A typical example is shown in FIG. 4. In one embodiment, the speckle pattern may occur naturally on the surface due to characteristic marks or surface features. Natural patterns may include wood grain, metal surface texture, metal microstructure features, skin texture, masonry surface features, carpet color variations, plastic surface color and texture variations.

In another embodiment, artificial object preparation is performed to bond a speckle pattern to the object surface. Artificial preparation methods may include spray painting, hand painting and paint splattering to obtain a speckle pattern on a homogeneous background.

In another embodiment of the method, a non-random pattern may be applied across the visible object surface. Typical patterns include line grids, crossed line grids, an array of dots or other symbols.

In another embodiment of the method, a combination of random and non-random patterns may be applied to the visible surface of the object.

Extraction of Object Motions from Image Data

In the preferred embodiment of the method, a calibrated stereo camera system is uses to acquire simultaneous images of the object from different viewing angles. Well-known matching and correlation methods are used to identify corresponding subsets (points) on the patterned object surface in each of the stereo images of the object surface. Then, for each phase shift, well-known triangulation methods are used to determine the three-dimensional position of each point (subset) on the object surface. Using this procedure, full-field measurement of the amplitude and phase of the object motion during the oscillation process is performed.

### Camera Calibration

In the preferred embodiment of the method, accurate determination of Full-field spatial amplitude and phase uses a calibration process for the stereo camera system that considers and removes the effects of image distortion. Here, calibration refers to the optimal estimation of camera and distortion model parameters, as well as the determination of the relative position of multiple cameras. There is a wide variety of suitable calibration procedures. The calibration process typically consists of acquiring one or more images of a calibration target. The preferred calibration procedure requires multiple images in different orientations of a calibration target and employs the so-called bundle-adjustment method to solve the resulting mathematical equations for camera parameters, distortion coefficients as well as camera orientation.

### Object Motion Determination

In the preferred embodiment of the method, the calibrated cameras and stereo-vision system is employed to analyze the images acquired during vibration of the object and determine the full-field motion, phase maps, deformations and strains of the object. Once determined, the full-field motions are converted into a coordinate system that is aligned with an appropriate local object outline and/or the surface-normal of the object. Once converted into the local system, the object motions can be converted into local measures of relative motion, i.e., strain of the object surface.

In another embodiment of the method, images of the patterned object surface can be acquired in a state of rest (without trigger measures). This image can be used in particular as a “reference state” during the determination of object motions, where object motions would be determined relative to the “reference state”.

### Determination of Object Response

In all cases, it is necessary to ensure that least two measurements per cycle of oscillation are obtained so that the well-known Nyquist criterion for reconstruction of the periodic response is not violated. In this regard, the measurement in a state of rest may be included in the analysis in order to be able to calculate the periodic response. In all cases, a higher number of object measurements with well-known relative phase positions are helpful in order to increase the accuracy of the measured periodic response, i.e. amplitude and phase of the quantity being measured.

In the preferred embodiment of the method, the relative phase positions (13 in FIGS. 1,2) of the trigger times are selected relative to the observed oscillation process so that the measured object motions at each phase and knowledge of the time between each measurement are used to determine the periodic response of the object.

In another embodiment of the method, the relative phase position for each measurement is given either by the measurement system or by the knowledge of the excitation frequency and time shifts between measurements. Then, the object motion measurements can be combined with the fixed phase shifts to determine the periodic response.

In another embodiment, a fixed time between measurements is used in the triggering system (13). Then, the object motion measurements can be combined with the fixed time increments to determine the periodic response.

In another embodiment of the method, where the relative phase positions are unknown, if the same time increment is used between triggering then it is possible to solve for the periodic response (amplitude and phase) of the determined quantities, in particular the deformations and the strains in the case of harmonic oscillation processes.

All of the embodiments noted above apply to the determination of the periodic response of any full-field quantity measured at various times and relative phase positions. Full-field object motion quantities measured by the stereo camera system include, but are not limited to, the following; (a) object displacement components, (b) velocity components, (c) acceleration components, (d) surface strain components. The displacement, velocity and acceleration components may be 1D, 2D or 3D.

### Non-Periodic Excitation and Response

For non-harmonic oscillations of an object due to non-linear material behavior or variations in structural rigidity, the preferred embodiment of the method is to acquire a dense set of measurements spanning across one period through control of the relative phase positions during the triggering process. The evaluation of the amplitudes and phases of the quantity of interest during one period of the procedure is made directly in each case in relation to an arbitrary reference state (e.g., initial rest position or another reference condition preferably zero crossover). Then, the data for quantity of interest can be combined with the fixed time increments to determine the periodic response.

### Additional Object Response Measurements

The determination of the periodic response for a quantity of interest can be performed in a relatively short time so that the time history of quantities such as the peak-to-peak swing and, if necessary, the phase can be computed rapidly. The results can be used to perform real-time identification of important states of the object, including conditions such as vibratory resonance and maximum strain ranges.

In another embodiment of the method, the real-time data obtained by the method may be used for automatic, active control of the external excitation frequency via the synchronization system. The automatic, active control can be used to minimize (maximize) specific input quantities such as force.

In another embodiment, the automatic, active control can be used to visit the local maximum (minimum) in quantities of interest such as the amplitude of object response or the maximum normal strain.

In another embodiment of the method, the criterion for the automatic or manual search of the resonant frequency can employ gradients in the quantities of interest with frequency change (e.g., dA/df and/or dP/df, where A is the amplitude of the object motion and P is the applied external force)

For those cases where the periodic response as a function of phase has been determined, special emphasis can be placed on the reversal points, i.e. at maximum amplitude or minimum amplitude where the object speed is low. At these locations, sharp, clearly focused images can be obtained, analyzed and presented to the user for visual “stroboscopic” observation of the object motions. In another embodiment of the method, similar presentations of data can be performed for surface strains, velocities, accelerations and other quantities of interest.

1. A method for the measurement and visualization of the shape and deformations incurred by objects subjected to vibratory excitation comprising
An imaging and image acquisition unit
A signal analysis and synchronization unit
An image analysis system
A means to communicate between the signal analysis and synchronization unit and the vibratory excitation unit so that information can be transferred between the two units for analysis of the vibratory excitation signal.
A means to communicate between the synchronization unit and (a) the imaging and image acquisition unit, (b) the excitation unit and (c) the image analysis so that information can be transferred between the various units.
A means to apply an appropriate characteristic pattern to the object surface for use in image/pattern matching.
A means to extract information from the images and determine the object shape, object motion and object deformations from images at each time of interest.

2. The system as recited in claim 1 whereby the imaging and image acquisition unit is comprised of a multi-camera stereo system. The stereo camera system may have two or more imaging and image acquisition units (cameras).
A means to store the images acquired by the imaging and image acquisition unit in digital form.
A means to calibrate the stereo camera system to obtain estimates for the stereo camera system parameters.

3. The system as recited in claim 1 whereby calibration of the stereo camera system is performed using any combination of the following methods with well known procedures for using the resulting data to determine stereo camera system model parameters. The procedures involve several arbitrary, three-dimensional rigid body motions of an object such as (a) a grid or feature pattern; (b) planar objects with characteristic pattern with digital image correlation, (c) an object having an estimated size in at least one direction.

4. The system as recited in claim 1 whereby the pattern applied to the object surface has a variation in contrast/intensity across the object surface. The variation in contrast may be random (known as a speckle pattern), non-random or a combination of both random and non-random. The pattern may occur naturally on the surface or the pattern may be applied artificially on the object surface. Examples of artificial preparation methods include spray painting, hand painting and paint splattering on a homogeneous background. Examples of non-random patterns include lines, grids and symbols such as circles or trapezoids

5. The system as recited in claim 1 whereby digital image correlation methods with calibrated stereo camera systems are used to identify matching points and/or subsets in the characteristic pattern throughout the full field within the sets of images. Camera parameters are used with the matched subsets from reference images and images at time, t, to determine the whole-field, three-dimensional positions of points at each time, t, of interest.

6. The system as recited in claim 5 whereby data obtained using the calibrated cameras and stereo-vision system at each time during the vibration of the object includes full-field motions, phase shifts and deformations of the object. The motions may be determined in 1D, 2D or 3D as needed. The positions of the object at time t=0 (at rest) is a subset of the measured data and is oftentimes used as the “reference state”.

7. The system as recited in claim 6 whereby at each time a coordinate system is defined at each point that is aligned with an appropriate local object outline and/or the surface-normal of the object. The object motions at each time are converted into local measures of relative 3D object motion and surface deformations in the appropriate local system on the object surface.

8. The system as recited in claim 1 whereby the image analysis and synchronization unit is used to analyze input signals related to the periodic excitation of the object and output time-synchronized signals to all units. The excitation-related signal received by the synchronization component is analyzed to determine the primary periodic frequency component. This information is used to define the relative phase position of the output trigger pulses to the various units.

9. The system as recited in claim 1 whereby the periodic excitation of the object is obtained as an output directly from the object excitation unit is used as the periodic excitation signal, input to the signal analysis and synchronization unit and analyzed by the unit. This information is used to define the relative phase position of the output trigger pulses to the various units.

10. The system as recited in claim 1 whereby the signal analysis and synchronization unit sends trigger signals to the imaging and acquisition unit to control exposure time and freeze the images by using a sufficiently short exposure time.

11. The system as recited in claim 1 whereby the frequency of the output signal from the signal analysis and synchronization unit to the imaging and image acquisition unit that controls the image acquisition process is the quotient of the primary frequency of the excitation signal and a divisor. The divisor is chosen so that images are acquired at a range of phase angles in N cycles of oscillation, N≧1.

12. The system as recited in claim 9 whereby the object measurement data at each time and appropriate combinations of the following (when data is known) are used to determine the periodic response of the object:
primary periodic excitation frequency determined by the signal analysis and synchronization unit;
frequency of the signal from signal analysis and synchronization unit that controls the image acquisition system;
relative timing between image acquisitions output by the signal analysis and synchronization unit to control the image acquisition system

13. The system as recited in claim 1 whereby triggering by the signal analysis and synchronization unit is modified to acquire a dense set of images to increase temporal resolution of object measurements with well-known relative phase positions. The increase in data is meaningful in order to increase the accuracy of the predicted periodic response, i.e. amplitude and phase of the quantity being measured.

14. The system as recited in claim 1 whereby the periodic response as a function of phase is used to identify the reversal points, i.e. at maximum amplitude or minimum amplitude where the object speed is low. At these locations, sharp, clearly focused images can be obtained, analyzed and presented to the user for visual “stroboscopic” observation of the object motions, surface strains, velocities or other quantities of interest.

15. The system as recited in claim 1, whereby an additional external sensor is added to quantify the excitation signal. The output from this signal is used as the periodic excitation signal and input to the signal analysis and synchronization unit for further analysis. This information is used to define the relative phase position of the output trigger pulses to the various units.

16. The system as recited in claim 15 whereby the signal analysis and synchronization unit sends trigger signals to the imaging and acquisition unit to control exposure time and freeze the images by using a sufficiently short exposure time.

17. The system as recited in claim 15 whereby the frequency of the output signal from the signal analysis and synchronization unit to the imaging and image acquisition unit that controls the image acquisition process is the quotient of the primary frequency of the excitation signal and a divisor. The divisor is chosen so that images are acquired at a range of phase angles in N cycles of oscillation, N≧1.

18. The system as recited in claim 15 whereby the object measurement data at each time and appropriate combinations of the following (when data is known) are used to determine the periodic response of the object:
primary periodic excitation frequency determined by the signal analysis and synchronization unit;
frequency of the signal from signal analysis and synchronization unit that controls the image acquisition system;
relative timing between image acquisitions output by the signal analysis and synchronization unit to control the image acquisition system

19. The system as recited in claim 15 whereby triggering by the signal analysis and synchronization unit is modified to acquire a dense set of images to increase temporal resolution of object measurements with well-known relative phase positions. The increase in data is meaningful in order to increase the accuracy of the predicted periodic response, i.e. amplitude and phase of the quantity being measured.

20. The system as recited in claim 15 whereby the periodic response as a function of phase is used to identify the reversal points, i.e. at maximum amplitude or minimum amplitude where the object speed is low. At these locations, sharp, clearly focused images can be obtained, analyzed and presented to the user for visual “stroboscopic” observation of the object motions, surface strains, velocities or other quantities of interest.
